(19) United States
(12) Patent Application Publication
(10) Pub. No.: US 2018/0345735 A1
(43) Pub. Date: Dec. 6, 2018

(54) CERAMIC TIRE STUD

(71) Applicant: Dae-yong MUN, Seoul (KR)

(72) Inventor: Dae-yong MUN, Seoul (KR)

(21) Appl. No.: 15/757,920

(22) PCT Filed: Apr. 12, 2016
(86) PCT No.: PCT/KR2016/003852

§ 371 Date: Mar. 6, 2018

(30) Foreign Application Priority Data
Nov. 23, 2015 (KR) 10-2015-0163794

(51) Int. Cl. B60C 11/16; B29D 30/06

(52) U.S. Cl. CPC B60C 11/1675; B29D 30/0606

(57) ABSTRACT

The present invention relates to a tire stud, which enables a snow tire to be used in every season and is a ceramic tread structure, which: can be used in all weathers on dry roads, wet roads, and even on icy roads, reduces braking, handling, road frictional noise, and a tire inner heat generated during driving on a road; and has an integrated groove portion and pin, which are more advanced than a conventional metallic tread pin and groove portion, wherein the ceramic thread structure is an integrated ceramic stud, which is applied to various stud patterns such as an existing rib type, rug type, rib and rug type, block type, and asymmetrical type, is particularly suitable even for an airless tire, being a next-generation tire, and is made of ceramic.

### TECHNICAL FIELD

The present invention relates to a tire thread stud having a stud improved to allow for use of a snow tire in every season, and more particularly, to a tire mold that can prevent separation and deformation of a stud due to the weight of a vehicle and allows for use of a tire in four seasons and a material for a stud.

### BACKGROUND ART

A tire tread, which is a rubber layer that comes in contact with the surface of a road, has a continuous plurality of grooves and blocks, and various tires having metallic studs driven in thread blocks have been developed to improve the performance of preventing sliding and twisting of the tire when the tire is in contact with a wet road surface or icy road surface.

Despite these efforts, the technologies developed up to now are applied only to snow tires, so there is a limit in variety of use.

### CITATION LIST

### Patent Literature

[Patent Literature 1] KR 10-1997-0064984A

[Patent Literature 2] KR 10-2010-0065957A

### DISCLOSURE

### Technical Problem

The present invention has been made in an effort to solve the above problems and is a novel method of not inserting a stud into a completed tire as in the related art, but a method of a tire thread made of ceramic is fixed by a mold stud pin in a tire vulcanizing mold, and a vulcanizing process is performed such that the tire ceramic stud is embedded out of the mold in order to prevent separation of the stud due to poor insertion in the inserting method of the related art and separation property between rubber and a metallic stud, by using porosities on the surface of ceramic.

### Technical Solution

In order to achieve the above object, a mold stud pin is driven into a fastening portion formed with a female thread at the circumferential center of a block in a tire vulcanizing mold, a tire thread stud (ceramic) manufactured in advance to fit to the diameter of the thread is fitted, and then the vulcanizing process is kept performed such that the tire stud made of ceramic is embedded due to heat and pressure.

### Advantageous Effects

According to the tire thread molds in the related art, it is inconvenient to manufacture different molds for stud fitting grooves every time in accordance with patterns.

The ceramic stud tire using a mold stud pin in a mold manufactured in the above method has the advantage that the existing mold can be reused, a method of fastening a stud in a mold that is more accurate than a stud inserting method after completion is used, and separation and deformation that frequently occurs on the existing metallic tire studs are reduced due to porous absorption on a surface that is a characteristic of ceramic. Accordingly, the ceramic stud tire is suitable for particularly all-season tires and non-pneumatic tires.

### BRIEF DESCRIPTION OF DRAWINGS

FIG. 1 is a cross-sectional view showing a tire stud fixed by a mold stud pin at the center of a thread block in a tire vulcanizing mold.

FIG. 2A is a cross-sectional view showing a vulcanizing mold block having a female threaded-groove at the center of a thread block in a tire vulcanizing mold.

FIG. 2B is a view showing a mold stud pin having a male thread at the upper portion and a flat cylindrical shape at the lower portion.

FIG. 2C is a ceramic stud only for a tire.

FIGS. 3A and 3B are view showing ceramic studs passing through a tire.

### BEST MODE

### Mode for Invention

Hereinafter, the present invention will be described with reference to the accompanying drawings.

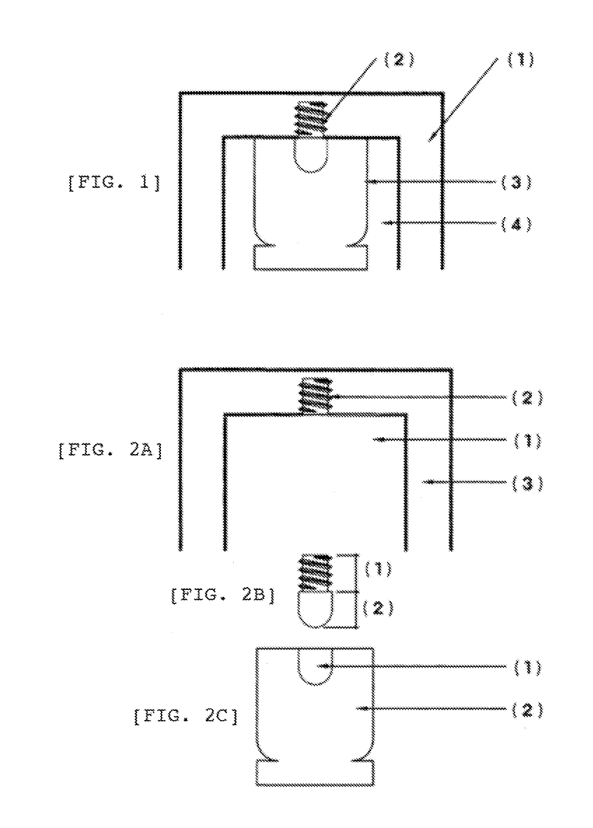

In a vulcanizing mold as indicated by (1) in FIG. 1, a female threaded-groove is formed at the center of a tire vulcanizing mold block formed in the axial direction and the circumferential direction of a tire as indicated by (2) in FIG. 1, and a cylindrical rod-shaped mold stud pin having a male thread at the upper portion (portion where a vulcanizing mold is fastened) and a flat surface at the lower portion (portion fixing the tire stud) is fastened to the female threaded-groove, as in FIG. 2B.

In this process, the ceramic stud manufactured by hot pressing, reactive sintering, normal sintering, and HIP, etc. only for a tire thread, that is, a ceramic stud indicated by (1) in FIG. 2C and having a fixing portion groove fitted to the shape of the lower flat cylindrical shape at the lower portion except for the male thread at the upper portion of a mold stud at the center of the upper portion of the body is fitted, as in FIG. 2C.

Next, a green tire is put into the vulcanizing mold and sufficient heat and pressure are applied.

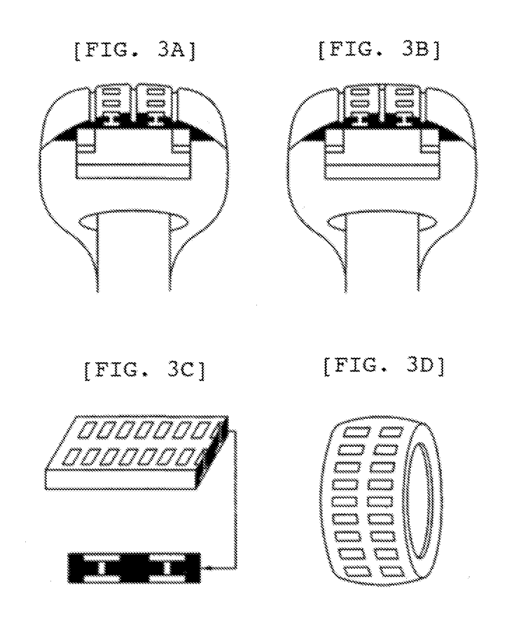

Next, a tire with a stud is separated from the vulcanizing mold and achieved as in FIGS. 3A and 3B.

### REFERENCE NUMERALS

[FIG. 1]
(1) Vulcanizing mold
(2) Mold stud pin
(3) Stud for ceramic tire
(4) Green tire

[FIG. 2]
(A)
(1) Vulcanizing mold
(2) Female threaded-groove in mold
(3) Green tire
(B) Mold stud pin
(B)
(1) Male thread at upper portion
(2) Flat cylindrical shape at lower portion
(C) Ceramic stud
(C)
(1) Mold stud fitting groove
(2) Stud body with unevenness

1. A method of inserting a tire stud through a tire thread comprising:
providing a tire vulcanizing mold;
inserting the tire stud into the tire vulcanizing mold;
inserting a tire into the tire vulcanizing mold;
performing a tire vulcanizing process in the tire vulcanizing mold; and
separating the tire with the tire stud from the tire vulcanizing mold.

2. A tire stud made of a ceramic.

3. The tire stud according to claim 2, wherein the ceramic is an engineering ceramics.

4. The tire stud according to claim 3, wherein the engineering ceramics is one of silicon nitride ceramics, silicon carbide ceramics, SiAlON ceramics, alumina ceramics, zirconia ceramics, bioceramics, titania ceramics, BaTiO₃ ceramics, SrTiO₃ ceramics, silica ceramics, cordierite ceramics, mica ceramics, SiO ceramics, and Sian₄ ceramics.

5. The tire stud according to claim 2, wherein a size of the tire stud is determined by sizes of tire thread patterns and each of a width and a length of the tire stud is 5 mm to 50 mm.

6. The tire stud according to claim 2, wherein the tire stud has an unevenness at a center or a lower portion of the tire stud, and has a hole having the same diameter and the same depth as those of a mold stud pin in a tire vulcanizing mold at an upper portion or a center thereof.

7. The tire stud according to claim 2, wherein each of a width and a length of the tire stud is 5 mm to 50 mm.
